(19) United States
(12) Patent Application Publication
(10) Pub. No.: US 2021/0316909 A1
(43) Pub. Date: Oct. 14, 2021

(54) Storage Device with Multi-Function Lid

(71) Applicant: Milwaukee Electric Tool Corporation, Brookfield, WI (US)

(72) Inventors: Matthew Vargo, Milwaukee, WI (US); Joshua J. McComb, Peachtree, GA (US)

(21) Appl. No.: 17/236,661

(22) Filed: Apr. 21, 2021

Related U.S. Application Data
(63) Continuation of application No. PCT/US2021/027079, filed on Apr. 13, 2021.
(60) Provisional application No. 63/009,734, filed on Apr. 14, 2020.

(51) Int. Cl. B65D 43/02; B65D 21/02

(52) U.S. Cl. CPC B65D 43/0212; B65D 21/023; B65D 21/0217; B65D 2543/00694; B65D 2543/00194; B65D 2543/00953; B65D 2543/00537

(57) ABSTRACT

Various products that couple with modular storage units are shown. In one example, a modular storage unit includes a detachable top panel that can itself be coupled to other objects, such as a building wall or a vehicle. The top panel includes a coupling mechanism that faces away from the building wall or vehicle, thereby allowing the housing to be coupled to the top panel. In another example, a drinking container includes a coupling mechanism to couple the drinking container to a modular storage unit.

### CROSS-REFERENCE TO RELATED PATENT APPLICATION

The present application is a continuation of International Patent Application No. PCT/US2021/027079, filed on Apr. 13, 2021, which claims the benefit of and priority to U.S. Provisional Application No. 63/009,734, filed on Apr. 14, 2020, which are incorporated herein by reference in their entireties.

### BACKGROUND OF THE INVENTION

The present disclosure relates generally to the field of storage units. The present disclosure relates specifically to a modular storage unit with a multi-functional top panel.

Storage units are often used to transport tools and tool accessories. Some storage units are designed to be easily transported, some are designed to be stationary, and some are designed with either possibility in mind. Modular storage units are configured to be coupled to different objects, including other modular storage units and/or components thereof.

### SUMMARY OF THE INVENTION

One embodiment of the invention relates to a storage unit including a housing, a bottom surface defined by the housing, a top panel reversibly mechanically coupled to a top of the housing, a storage compartment collectively defined by the housing and the top panel when the top panel is in a closed position, a lateral face, a first coupler, a top surface, and a second coupler. The lateral face extends between the bottom surface and the top panel when the top panel is in the closed position. The first coupler is defined by the lateral face of the housing. The top surface is defined by the top panel. The top surface and the bottom surface face away from each other when the top panel in the closed position. The second coupler is defined by the top surface. The second coupler is engageable with the first coupler of the lateral face.

Another embodiment of the invention relates to a storage unit including a housing, a bottom surface defined by the housing, a first coupler, a lid, a storage compartment, a top surface defined by the lid, and a second coupler defined by the top surface. The first coupler is defined by the bottom surface of the housing, and the first coupler is engageable with a second storage unit. The lid is reversibly mechanically coupled to a top of the housing via a first latch and a second latch. The first latch is pivotally coupled to a front of the housing and the second latch is pivotally coupled to a rear of the housing opposite the front. The first latch and the second latch engage with the lid when the lid is in a closed position. The storage compartment is collectively defined by the housing and the lid when the lid is in a closed position. The top surface and the bottom surface face away from each other when the lid in the closed position. The second coupler is defined by the top surface, and the second coupler is engageable with the first coupler.

Another embodiment of the invention relates to a method of using a storage unit. The method includes reversibly mechanically coupling a top panel to a housing of a storage unit. The housing and the top panel collectively define a storage compartment. The top panel defines a top surface that faces away from the storage compartment when the top panel is coupled to the housing in a closed position. The top panel includes a first coupler. The housing includes a second coupler defined by a lateral surface of the housing. The method further includes reversibly mechanically decoupling the top panel from the housing, securing the top panel to a structure, and coupling the second coupler of the housing to the first coupler of the top panel such that the storage unit is supported from the structure.

In one embodiment, a storage device, container or unit includes including a housing, a bottom face defined by the housing, a first coupler defined by the bottom face of the housing, the first coupler engageable with a second container, a top panel detachably coupled to a top of the housing in a closed position, a storage compartment collectively defined by the housing and the top panel when the top panel is in the closed position, a top surface defined by the top panel, the top surface and the bottom surface facing away from each other when the top panel in the closed position, and a second coupler defined by the top surface. The second coupler is engageable with the first coupler. The coupling mechanism between the housing and the top panel permits the top panel to be completely detached from the housing.

In a specific embodiment, one or more lateral walls extend from the bottom surface of the housing to a top of the housing. The one or more lateral walls include a third coupler that couples to the second coupler defined by the top surface of the top panel.

In one exemplary method of using a storage device, container or unit such as a storage unit, a top panel is coupled to a top of a housing of a storage unit. The housing includes a storage compartment collectively defined by the housing and top panel when the top panel is coupled to the top of the storage unit in a closed position, a top surface defined by the top panel, the top surface facing away from the storage compartment when the top panel in the closed position, a first coupler defined by the top surface, and a second coupler defined by one of a bottom surface and a lateral surface of the housing. The next step of using the storage unit includes decoupling the top panel from the top of the housing. Then the top panel is coupled to an object other than the housing, such as to a wall of a structure or a wall of a vehicle. Finally, the first coupler of the top surface is coupled to the second coupler of one of the bottom surface and the lateral surface thereby affixing the housing to a top panel at an elevated height. The contents within the storage compartment can then be seen and retrieved by a worker.

Additional features and advantages will be set forth in the detailed description which follows, and, in part, will be readily apparent to those skilled in the art from the description or recognized by practicing the embodiments as described in the written description and claims hereof, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

FIG. 1 is a perspective view of a modular storage unit, according to an embodiment.

FIG. 2 is another perspective view of the storage unit of FIG. 1.

FIG. 3 is another perspective view of the storage unit of FIG. 1.

FIG. 4 is a top view of the top panel of the storage unit of FIG. 1.

FIG. 5 is another perspective view of the storage unit of FIG. 1.

### DETAILED DESCRIPTION

Referring generally to the figures, various embodiments of a stackable storage device, container or unit are shown. Described herein are various embodiments of stackable and movable storage units, such as tool storage units. One or more of the units are configured to selectively couple and decouple with other units. The unit includes a top panel that is coupled to a top of the housing of the unit. The top panel is configured to be decoupled, removed or detached from the housing and coupled to an object other than the unit, such as a wall, with the formerly top surface of the top panel facing away from the object. In one embodiment, the storage unit is then coupled to the top panel via a side wall or a bottom wall of the housing such that storage unit is supported from the wall. This functionality provides a storage unit in which the top panel can selectively be coupled to the housing to enclose a storage compartment holding tools, or alternately the top panel can be coupled to another object (e.g., a wall, a vehicle), and the open housing can be supported from that object via mounting to the top panel.

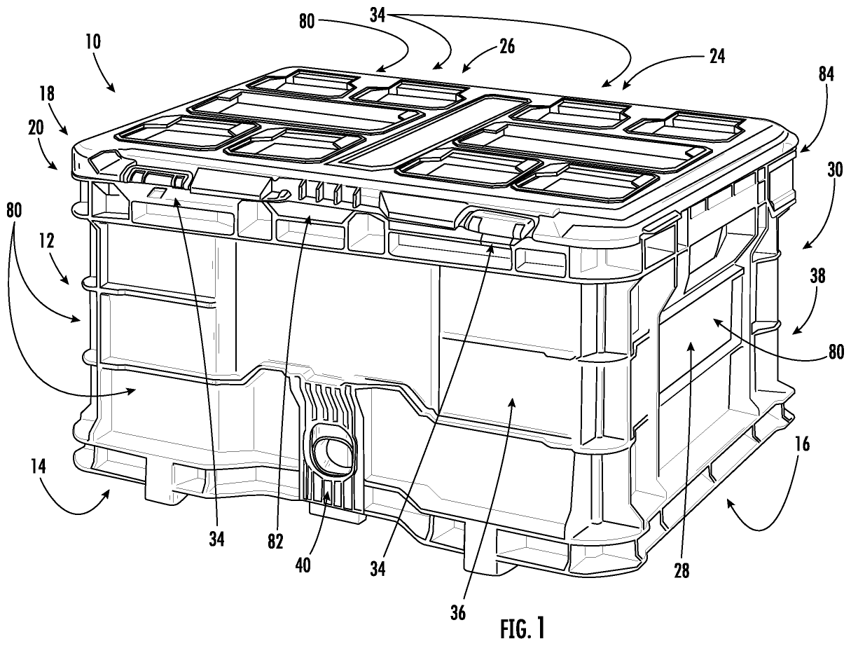

Referring to FIGS. 1-3, a storage unit, storage container or device, such as tool storage unit 10, is shown according to an exemplary embodiment. Tool storage unit 10 includes housing 12 and top panel 18. In the configuration shown in FIG. 1, top panel 18 is detachably coupled to top 20 of housing 12 in a closed position via latches 34. Top panel 18 and housing 12 collectively define storage compartment 22 when top panel 18 is in the closed position. In a specific embodiment, top panel 18 is coupled to housing 12 via four latches 34, two latches 34 coupling top panel 18 to front face 36 of housing 12 and two latches 34 coupling top panel 18 to back face 38 of housing 12. In a specific embodiment top panel 18 is coupled to top 20 of housing 12 via latches 34 to create an IP65 seal.

Top panel 18 defines top surface 24, which defines coupler 26. Housing 12 defines bottom surface 14, which defines coupler 16. Top surface 24 of top panel 18 faces away from bottom surface 14 of housing 12 when top panel 18 is in the closed position. Coupler 26 of top surface 24 is configured to engage with coupler 16 of bottom surface 14. Coupler 16 of bottom surface 14 also couples with other modular storage units with similar couplers.

Housing 12 includes one or more lateral faces 80 that extend between bottom surface 14 and top panel 18 when top panel 18 is in the closed position. In a specific embodiment, lateral faces 80 includes side faces 28, front face 36, and back face 38. Side faces 28, front face 36, and back face 38 extend from bottom face 14 to top 20 of housing 12. In a specific embodiment, one or more of lateral faces 80 define coupler 30, such as back surface 38 defining coupler 30. Coupler 30 of back surface 38 is configured to engage with coupler 26 of top surface 24.

In specific embodiments, the coupling mechanisms utilized in the units (e.g., tool storage units) discussed herein are described in International Patent Application No. PCT/US2018/044629, which is incorporated herein by reference in its entirety.

When tool storage unit 10 is stacked on top of another tool storage unit with similar coupling mechanisms, coupler 16 of bottom face 14 of storage unit 10 couples with the top surface of the other tool storage unit. Latch 40 engages with the other storage unit to secure the two storage units together.

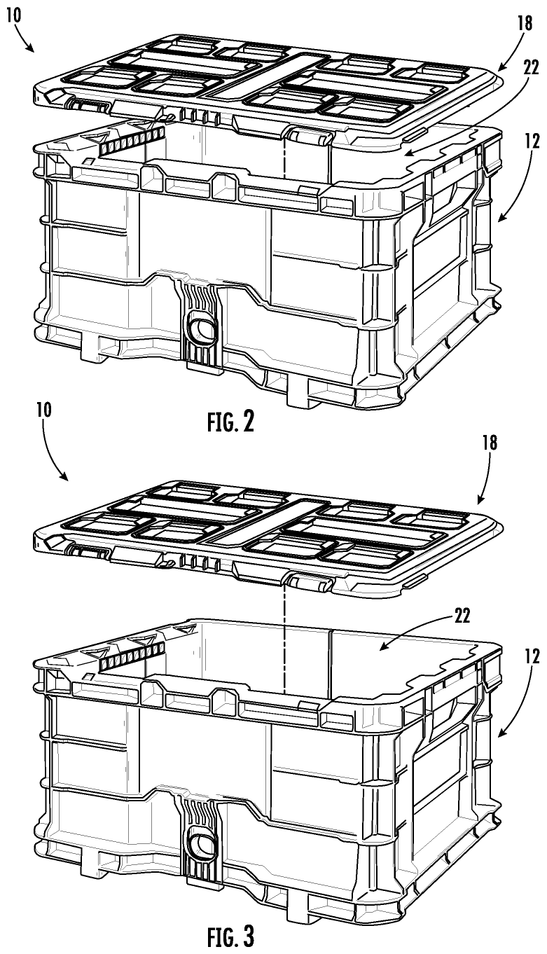

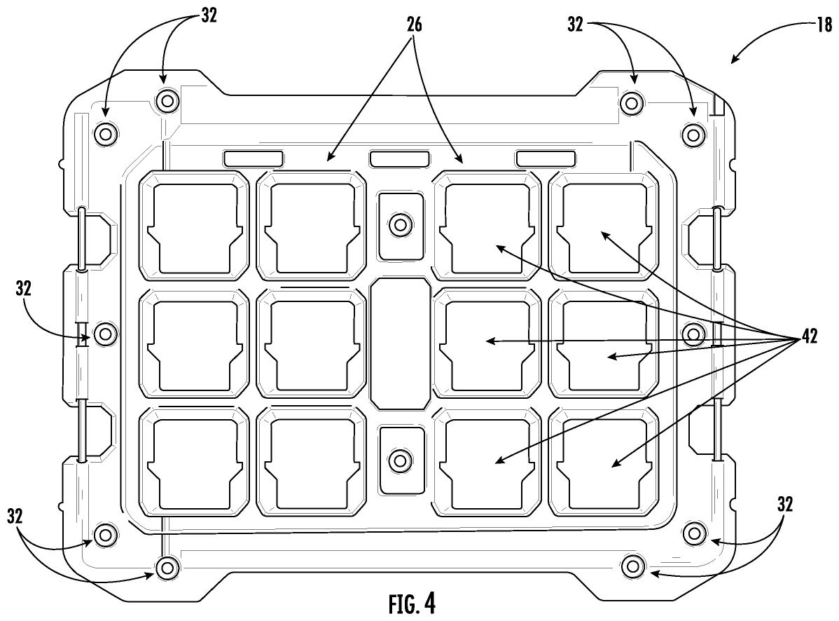

Turning to FIGS. 2-3 in particular, depicted are various configurations of tool storage unit 10 with top panel 18 in different positions with respect to housing 12. In a specific embodiment, top panel 18 is coupled to housing via first latch 34 pivotally coupled to a front 82 of housing 12 and a second latch 34 pivotally coupled to a rear 84 of housing 12. The first latch 34 and second latch 34 engage the top panel 18 when the top panel 18 is in the closed position, and in a specific embodiment top panel 18 and housing 12 create an IP65 seal. In a specific embodiment, top panel 18 is coupled to housing via latch 34 pivotally coupled to a rear 84 of housing 12 and the latch 34 engages top panel 18 when the top panel 18 is in the closed position. After latches 34 are decoupled from the position shown in FIG. 1, top panel 18 can be moved away from housing 12 thereby exposing storage compartment 22.

In a specific embodiment, one or more of latches 34 reversibly mechanically couple top panel 18 to housing 12 such that latches 34 mechanically actuate between coupling and decoupling top panel 18 and housing 12, and coupling and decoupling top panel 18 and housing 12 via the one or more latches 34 does not involve assembly and/or disassembly of the one or more latches 34. In a specific embodiment, the one or more latches 34 coupling top panel 18 and housing 12 remain coupled to the housing 12 while the top panel 18 is decoupled from housing 12 (e.g., the pivoting portion of latch 34 pivots away from top panel 18 while the fixed portion of latch 34 remains coupled to housing 12).

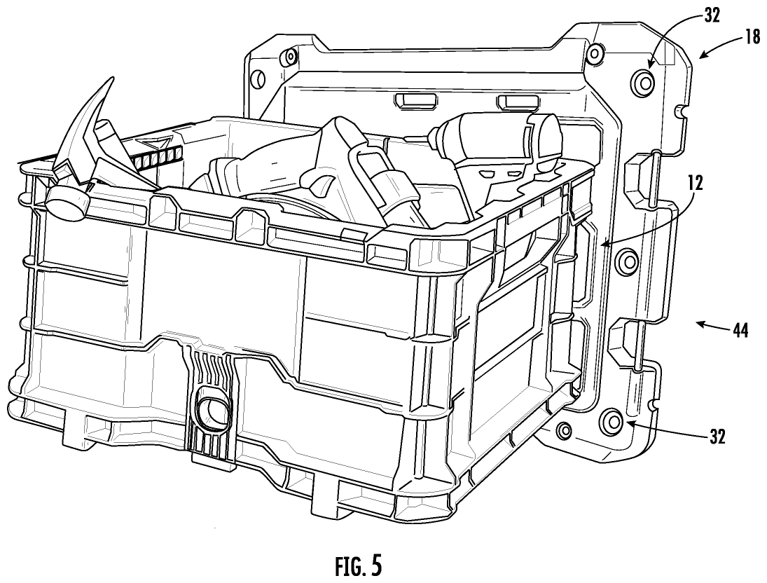

Turning to FIG. 4, various aspects of top panel 18 are depicted. Top panel 18 includes coupler 26. In a specific embodiment, coupler 26 includes a plurality of coupling elements, such as coupling recesses, shown as recesses 42 (e.g., coupler 26 includes twelve recesses 42). In a specific embodiment, recesses 42 are positioned in a grid arrangement. In an alternate embodiment, coupler 26 includes recesses and/or cleats such as shown in International Patent Application No. PCT/US2018/044629.

Turning to FIG. 5, various aspects of coupling top panel 18 to housing 12 are shown. In one method of using top panel 18, top panel 18 is reversibly mechanically coupled to top 20 of housing 12. Then, top panel 18 is reversibly mechanically decoupled from top 20 of housing 12 (e.g., from the position shown in FIG. 1). Subsequently, top panel 18 is removed from housing 12 (FIGS. 2 and 3). Top panel 18 is then secured to a support structure, such as a pillar, vehicle frame or wall, or building wall 44. For example, top panel 18 is coupled to wall 44 via a coupling mechanism, shown as apertures 32, which are coupled to fasteners, such as screws, that extend from the object (best shown in FIG. 5) and are configured to couple top panel 18 to the support structure. In a specific embodiment, a fastener extending through aperture 32 couples the top panel 18 to a structure. The structure supports storage unit 10 when coupler 30 of lateral face 80 is coupled to coupler 26 of top panel 18. In alternate embodiments, top panel 18 includes other coupling systems, such as E-track compliant couplers.

In one example, top panel 18 is coupled to wall 44 via apertures 32 such that coupler 16 of top panel 18 faces laterally (best shown in FIG. 5). Housing 12 is then affixed to top panel 18 at an elevated height by being coupled to the object (e.g., wall) via top panel 18.

In a specific embodiment, back surface 38 has couplers 30 to couple housing 12 to top panel 18 (such as shown in FIG. 5). In alternate embodiments, lateral surfaces 28 has couplers to couple housing 12 to top panel 18, and front surface 36 has couplers to couple housing 12 to top panel 18. In a specific embodiment, couplers of storage unit 10 are compliant with cleats of Milwaukee Tool product 48-22-8440.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the invention relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

What is claimed is:

1. A storage unit comprising:
a housing;
a bottom surface defined by the housing;
a top panel reversibly mechanically coupled to a top of the housing;
a storage compartment collectively defined by the housing and the top panel when the top panel is in a closed position;
a lateral face that extends between the bottom surface and the top panel when the top panel is in the closed position;
a first coupler defined by the lateral face of the housing;
a top surface defined by the top panel, the top surface and the bottom surface facing away from each other when the top panel in the closed position; and
a second coupler defined by the top surface, wherein the second coupler is engageable with the first coupler of the lateral face.

2. The storage unit of claim 1, comprising a first latch and a second latch that reversibly mechanically couple the housing to the top panel, wherein the first latch is coupled to a front of the housing and the second latch is coupled to a rear of the housing opposite the front, wherein the first latch and the second latch pivotally engage with the top panel when the top panel is in the closed position.

3. The storage unit of claim 2, wherein the top panel and the housing create an IP65 seal when the first latch and the second latch are engaged with the top panel.

4. The storage unit of claim 1, comprising:
a latch pivotally coupled to a rear of the housing opposite a front of the housing, wherein the latch engages with the top panel when the top panel is in the closed position.

5. The storage unit of claim 1, wherein the second coupler of the top panel comprises a plurality of coupling recesses positioned in a grid arrangement.

6. The storage unit of claim 1, further comprising a third coupler defined by a bottom surface of the housing, wherein the second coupler of the top panel engages with a third coupler.

7. The storage unit of claim 1, the top panel further comprising an aperture that receives a fastener, the fastener configured to couple the top panel to a structure.

8. The storage unit of claim 7, wherein the structure supports the housing when the first coupler of the lateral face is coupled to the second coupler of the top panel.

9. A storage unit comprising:
a housing;
a bottom surface defined by the housing;
a first coupler defined by the bottom surface of the housing, the first coupler engageable with a second storage unit;
a lid reversibly mechanically coupled to a top of the housing via a first latch and a second latch, wherein the first latch is pivotally coupled to a front of the housing and the second latch is pivotally coupled to a rear of the housing opposite the front, wherein the first latch and the second latch engage with the lid when the lid is in a closed position;
a storage compartment collectively defined by the housing and the lid when the lid is in a closed position;
a top surface defined by the lid, the top surface and the bottom surface facing away from each other when the lid in the closed position; and
a second coupler defined by the top surface, wherein the second coupler is engageable with the first coupler.

10. The storage unit of claim 9, wherein the lid and the housing create an IP65 seal when the first latch and second latch couple the lid to the housing.

11. The storage unit of claim 9, wherein the second coupler of the lid comprises a plurality of coupling elements positioned in a grid arrangement.

12. The storage unit of claim 9, further comprising a third coupler defined by a bottom face of the housing, wherein the second coupler of the lid engages with a third coupler.

13. The storage unit of claim 9, further comprising a third latch pivotally coupled to the housing and a fourth latch pivotally coupled to the housing, wherein the third latch and the fourth latch engage with the lid when the lid is in the closed position.

14. A method of using a storage unit comprising:
reversibly mechanically coupling a top panel to a housing of a storage unit, wherein the housing and the top panel collectively define a storage compartment, the top panel defining a top surface that faces away from the storage compartment when the top panel is coupled to the housing in a closed position, the top panel comprising a first coupler, the housing comprising a second coupler defined by a lateral surface of the housing;
reversibly mechanically decoupling the top panel from the housing;
securing the top panel to a structure; and
coupling the second coupler of the housing to the first coupler of the top panel such that the storage unit is supported from the structure.

15. The storage unit of claim 14, wherein the second coupler of the top panel comprises a plurality of coupling elements positioned in a grid arrangement.

16. The storage unit of claim 14, the top panel further comprising an aperture that receives a fastener, the fastener configured to couple the top panel to the structure.

17. The storage unit of claim 14, the top panel further comprising a plurality of apertures arranged around the top panel, the plurality of apertures each configured to receive a fastener that couples the top panel to the structure.

18. The storage unit of claim 14, the storage unit comprising a first latch and a second latch, wherein the first latch is coupled to a front of the housing and the second latch is coupled to a rear of the housing opposite the front, wherein the first latch and the second latch remain coupled to the housing while the top panel is decoupled from the housing.

19. The storage unit of claim 18, wherein the second coupler of the top panel comprises a plurality of coupling elements positioned in a grid arrangement.

20. The storage unit of claim 14, further comprising a third coupler defined by a bottom face of the housing, wherein the second coupler of the top panel engages with a third coupler.
